(19) United States
(12) Patent Application Publication
(10) Pub. No.: US 2026/0370266 A1
(43) Pub. Date: Nov. 19, 2026

(54) WIRELESS COMMUNICATION SYSTEM, ANTENNA DIRECTION CONTROL DEVICE, ANTENNA DIRECTION CONTROL METHOD AND ANTENNA DIRECTION CONTROL PROGRAM

(71) Applicant: NTT, Inc., Tokyo (JP)

(72) Inventors: Hiroyuki FURUYA, Musashino-shi, Tokyo (JP); Toshifumi MIYAGI, Musashino-shi, Tokyo (JP)

(73) Assignee: NTT, Inc., Tokyo (JP)

(21) Appl. No.: 18/995,911

(22) PCT Filed: Jul. 27, 2022
(86) PCT No.: PCT/JP2022/028908

§ 371 Date: Jan. 17, 2025

(51) Int. Cl. H04B 7/0413; H01Q 3/26

(52) U.S. Cl. CPC H04B 7/0413; H01Q 3/26

(57) ABSTRACT

A wireless communication system according to one embodiment includes two first antennas configured to transmit and receive an electromagnetic wave having a frequency higher than a predetermined frequency to and from each other while facing each other, a plurality of pairs of second antennas configured to transmit and receive a direct wave having a frequency lower than the predetermined frequency to and from each other while facing each other, two support members each fixing one of the first antennas and a plurality of the second antennas, measurement circuitry configured to measure a difference between arrival times of the direct waves received by the plurality of second antennas fixed to one of the support members from the other identical second antennas, and detection circuitry configured to detect a shift in a facing direction between the first antenna and the other first antenna.

### TECHNICAL FIELD

The present invention relates to a wireless communication system, an antenna direction control device, an antenna direction control method, and an antenna direction control program.

### BACKGROUND ART

Wireless communication systems that realize high-speed and high-capacity wireless communication by using high-frequency electromagnetic waves represented by terahertz waves and light are known (see, for example, Non Patent Literatures 1 and 2). However, the high-frequency electromagnetic waves such as light have high directivity and narrow beam width. In such wireless communication systems, antennas need to accurately face each other (be axially aligned) in order to perform normal wireless communication.

Here, a device that transmits and receives light is referred to as an antenna regardless of whether the device emits light or receives light, similarly to an antenna that transmits and receives high-frequency radio waves. In addition, a state in which the antennas that perform transmission and reception face each other is also referred to as a state in which optical axes are aligned.

For example, a wireless communication system using a high-frequency electromagnetic wave is sometimes equipped with a GPS, a high-magnification camera, or the like only for adjusting directions of antennas. Then, it is sometimes necessary to correct angles of the antennas by capturing a variation in the directions of the antennas in a narrow receivable range.

In addition, in the wireless communication system using a high-frequency electromagnetic wave, a beam is generally thin, and communication interruption easily occurs even when a small obstacle crosses the transmission and reception devices. Conventionally, as measures against instantaneous interruption, a combination of frequency bands having different characteristics has been studied. However, conventional methods have remained ring aggregation (LAG) and simply summed up communication speeds of individual networks.

### CITATION LIST

### Non Patent Literature

Non Patent Literature 1: “Kosoku daiyoryo tsushin o jitsugen shita atarashii hikari musen tsushin sochi o kaihatsu (in Japanese) (Developing a New Free-space Optical Communication Terminal that Realizes High-Speed Broadband Communications)”, [online], NICT NEWS, [Retrieved on Jun. 30, 2022], the Internet <URL: https://www.nict.go.jp/publication/NICT-News/1005/01.html>
Non Patent Literature 2: Kazuhiko Wakamori, “Okugai hikari musen tsushin system no kaihatsu to shinraisei kojo ni kansuru kenkyu (in Japanese) (Study on Development and Reliability Improvement of Outdoor Optical Wireless Communication System)”, Osaka City University, Graduate School of Engineering, March 2008

### SUMMARY OF INVENTION

### Technical Problem

The wireless communication using a high-frequency band requires manual and fairly accurate (within a few degrees) alignment during initial installation. In addition, in the wireless communication using a high-frequency band, movement of devices is not often easy.

Further, attempting to widen an automatic correction range of the antenna direction causes an increase in device size that exceeds the size of the devices that contribute to normal communication, such as the antennas, lens, and mirror. The wireless communication system using a high-frequency band generally has a high speed and a large capacity, but communication is interrupted when an axis shift occurs as described above, and no information can be transmitted until reconnection. Therefore, it is difficult to grasp whether the interruption is caused by an obstacle or a device failure.

The present invention has been made in view of the above-described problems, and an object thereof is to provide a wireless communication system, an antenna direction control device, an antenna direction control method, and an antenna direction control program capable of easily correcting directions of two antennas that transmit and receive electromagnetic waves having a frequency higher than a predetermined frequency to and from each other while facing each other.

### Solution to Problem

A wireless communication system according to one embodiment of the present invention includes: two first antennas configured to transmit and receive an electromagnetic wave having a frequency higher than a predetermined frequency to and from each other while facing each other; a plurality of pairs of second antennas configured to transmit and receive a direct wave having a frequency lower than the predetermined frequency to and from each other while facing each other; two support members each fixing one of the first antennas and a plurality of the second antennas so as to be integrated toward a same direction, and the two support members configured to support the two first antennas and the plurality of the second antennas forming the pairs to respectively face each other within a predetermined movable range; a measurement unit configured to measure a difference between arrival times of the direct waves received by the plurality of second antennas fixed to one of the support members from the other identical second antennas; and a detection unit configured to detect a shift in a facing direction between the first antenna and the other first antenna on a basis of the difference between arrival times measured by the measurement unit.

Further, an antenna direction control device according to one embodiment of the present invention, which controls an antenna direction of a wireless communication system including two first antennas configured to transmit and receive an electromagnetic wave having a frequency higher than a predetermined frequency to and from each other while facing each other, a plurality of pairs of second antennas configured to transmit and receive a direct wave having a frequency lower than the predetermined frequency to and from each other while facing each other, and two support members each fixing one of the first antennas and a plurality of the second antennas so as to be integrated toward a same direction, and the two support members configured to support the two first antennas and the plurality of the second antennas forming the pairs to respectively face each other within a predetermined movable range, the antenna direction control device includes: a measurement unit configured to measure a difference between arrival times of the direct waves received by the plurality of second antennas fixed to one of the support members from the other identical second antennas; a detection unit configured to detect a shift in a facing direction between the first antenna and the other first antenna on a basis of the difference between arrival times measured by the measurement unit; and a correction unit configured to correct a direction of the first antenna fixed to the support member on a basis of the shift in the facing direction detected by the detection unit.

An antenna direction control method according to one embodiment of the present invention, for controlling an antenna direction of a wireless communication system including an antenna direction of a wireless communication system including two first antennas configured to transmit and receive an electromagnetic wave having a frequency higher than a predetermined frequency to and from each other while facing each other, a plurality of pairs of second antennas configured to transmit and receive a direct wave having a frequency lower than the predetermined frequency to and from each other while facing each other, and two support members each fixing one of the first antennas and a plurality of the second antennas so as to be integrated toward a same direction, and the two support members configured to support the two first antennas and the plurality of the second antennas forming the pairs to respectively face each other within a predetermined movable range, the antenna direction control method includes: a measurement process of measuring a difference between arrival times of the direct waves received by the plurality of second antennas fixed to one of the support members from the other identical second antennas; and a detection process of detecting a shift in a facing direction between the first antenna and the other first antenna on a basis of the measured difference between arrival times.

### Advantageous Effects of Invention

According to the present invention, it is possible to easily correct directions of two antennas that transmit and receive electromagnetic waves having a frequency higher than a predetermined frequency to and from each other while facing each other.

### BRIEF DESCRIPTION OF DRAWINGS

FIG. 1 is a diagram illustrating an outline of a configuration of a wireless communication system according to an embodiment.

FIG. 2(a) is a diagram illustrating a state in which two first antennas face each other. FIG. 2(b) is a diagram illustrating a state in which directions of the first antennas do not face each other.

FIG. 3 is a functional block diagram illustrating functions of an antenna direction control device according to an embodiment.

FIG. 4(a) is a diagram schematically illustrating a state in which two first antennas face each other. FIG. 4(b) is a diagram schematically illustrating a state in which the two first antennas do not face each other.

FIG. 5 is a diagram schematically illustrating a first operation example in a case where the wireless communication system corrects a direction of the first antenna.

FIG. 6(a) is a diagram illustrating a state in which the direction of a support member is inclined in a predetermined direction. FIG. 6(b) is a diagram illustrating positions where second antennas do not face each other, but differences between arrival times of radio waves received by the two second antennas are equal. FIG. 6(c) is a diagram illustrating positions where the second antennas do not face each other, but differences between arrival times of radio waves directly received for the respective pairs by the second antennas are equal. FIG. 6(d) is a diagram illustrating a process of determining an angle for correcting the support member by obtaining an intermediate angle of inclinations of the support member illustrated in FIGS. 6(c) and 6(d). FIG. 6(e) is a diagram illustrating a relationship of the angles illustrated in (d).

FIG. 7(a) is a diagram illustrating a state in which two first antennas face each other in a modification of the wireless communication system. FIG. 7(b) is a diagram illustrating a state in which the two first antennas do not face each other in the modification of the wireless communication system.

FIG. 8 is a diagram illustrating an example of the wireless communication system.

FIG. 9 is a diagram illustrating a hardware configuration example of an antenna direction control device according to an embodiment.

FIG. 10(a) is a diagram illustrating a state in which optical axes are aligned. FIG. 10(b) is a diagram illustrating a state in which the optical axes are shifted.

FIG. 11(a) is a diagram illustrating a state in which high-frequency band devices 2 using a high-frequency electromagnetic wave as a terahertz wave and FSO devices 1 using a high-frequency electromagnetic wave as light are blocked by obstacles. FIG. 11(b) is a diagram illustrating a wireless communication system that continues communication even when the FSO devices 1 are blocked by an obstacle.

### DESCRIPTION OF EMBODIMENTS

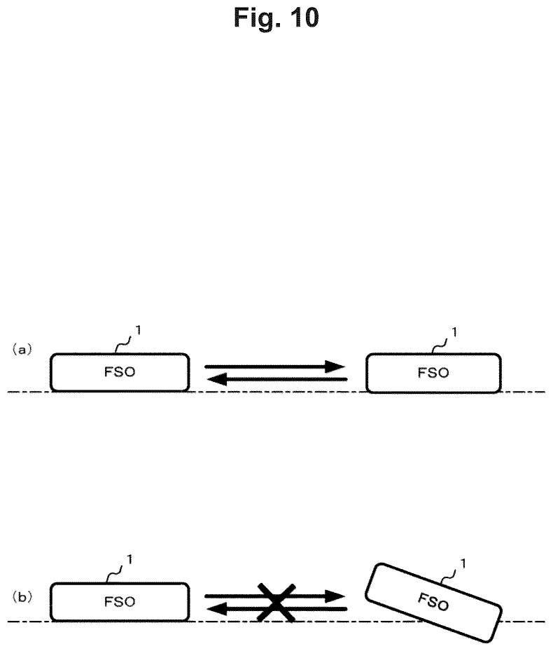

First, the background of the present invention will be described. FIG. 10 is diagrams illustrating orientation of antennas (orientation of optical axes) in a wireless communication system of a comparative example. FIG. 10(a) is a diagram illustrating a state in which the optical axes are aligned. FIG. 10(b) is a diagram illustrating a state in which the optical axes are shifted. Here, an electromagnetic wave having a frequency higher than a predetermined frequency is assumed to be light.

In free space optics (FSO), communication is immediately interrupted even if a position or an angle is slightly shifted. Two FSO devices 1 arranged to face each other need to maintain light quality equivalent to that in optical fibers in a space by devising an optical system such as a lens. Therefore, the FSO requires manual alignment and firm fixation of optical axes, and then tracks the opposing FSO devices 1 by an automatic capturing function (for example, with a correction range is ±1.2 degrees) and continues communication. For the correction range, vibration of installation structures (buildings or the like) due to wind or the like are taken into consideration, for example.

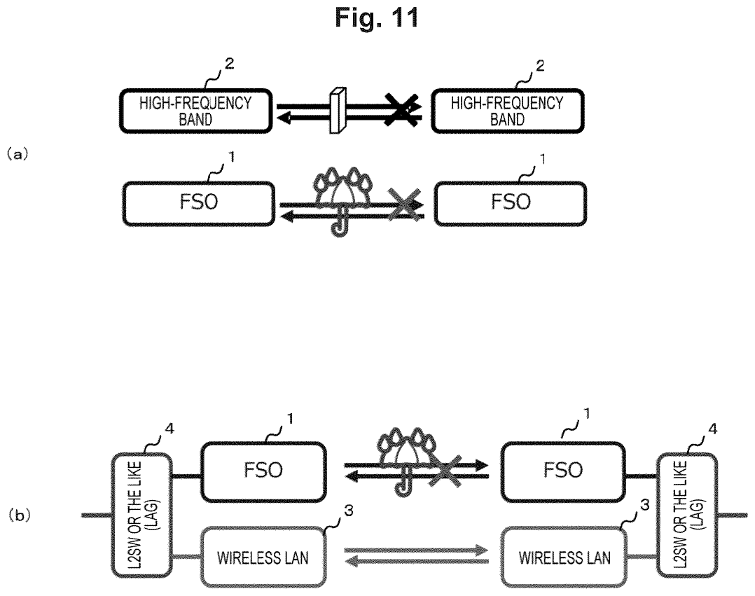

FIG. 11 is diagrams illustrating communication continuity in the wireless communication system of the comparative example. FIG. 11(a) is a diagram illustrating a state in which a high-frequency band device 2 using a high-frequency electromagnetic wave as a terahertz wave and the FSO device 1 using a high-frequency electromagnetic wave as light are blocked by an obstacle. FIG. 11(b) is a diagram illustrating the wireless communication system that continues communication even when the FSO device 1 is blocked by an obstacle.

As illustrated in FIG. 11(a), in the wireless communication system of the comparative example, the communication may be interrupted by a small obstacle, rainfall, or the like. Further, as illustrated in FIG. 11(b), in the wireless communication system of the comparative example, the FSO device 1 and a wireless LAN device 3 constitute link aggregation (LAG) by layer2 switch (L2SW or the like) 4, so that the communication can be continued (assisted) between the wireless LAN devices 3 even if the communication is interrupted between the FSO devices 1.

However, the wireless communication system of the comparative example illustrated in FIG. 11(b) only constitutes unit LAG, and the wireless LAN devices 3 do not contribute to recover the interruption of the communication between the FSO devices 1. That is, there is no interaction between a high-frequency band and a low-frequency band, and the link aggregation is merely set up as a wireless LAN technique.

Therefore, a wireless communication system according to an embodiment is configured to be able to easily correct directions of two antennas that transmit and receive electromagnetic waves having a frequency higher than a predetermined frequency to and from each other while facing each other.

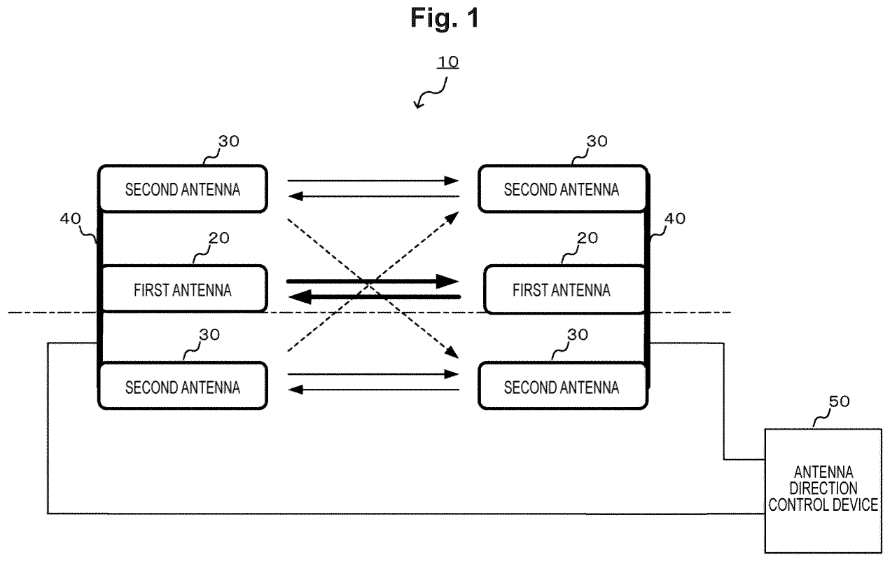

FIG. 1 is a diagram illustrating an outline of a configuration of a wireless communication system 10 according to an embodiment. As illustrated in FIG. 1, the wireless communication system 10 includes, for example, two first antennas 20 that transmit and receive electromagnetic waves having a frequency higher than a predetermined frequency while facing each other, a plurality of pairs (for example, two pairs=4) of second antennas 30 that transmits and receives direct waves having a frequency lower than the predetermined frequency while facing each other, two support members (platforms) 40 that each fixes one first antenna 20 and two second antennas 30 so as to be integrated in the same direction and that support the two first antennas 20 and the two pairs of second antennas 30 so as to face each other within a predetermined movable range, and an antenna direction control device 50.

For example, the plurality of pairs of second antennas 30 performs wireless communication of multiple-input and multiple-output (MIMO). Further, the two support members 40 are driven by a drive unit (not illustrated) to be able to change the directions within the predetermined movable range.

The wireless communication system 10 facilitates orientation (axial alignment) of the first antennas 20 by combining radios of a low frequency and a high frequency. For example, the wireless communication system 10 assists continuation of high-speed communication using the first antennas 20 that are vulnerable to environmental changes by using the second antennas 30. That is, the wireless communication system 10 facilitates operation for not interrupting the wireless communication.

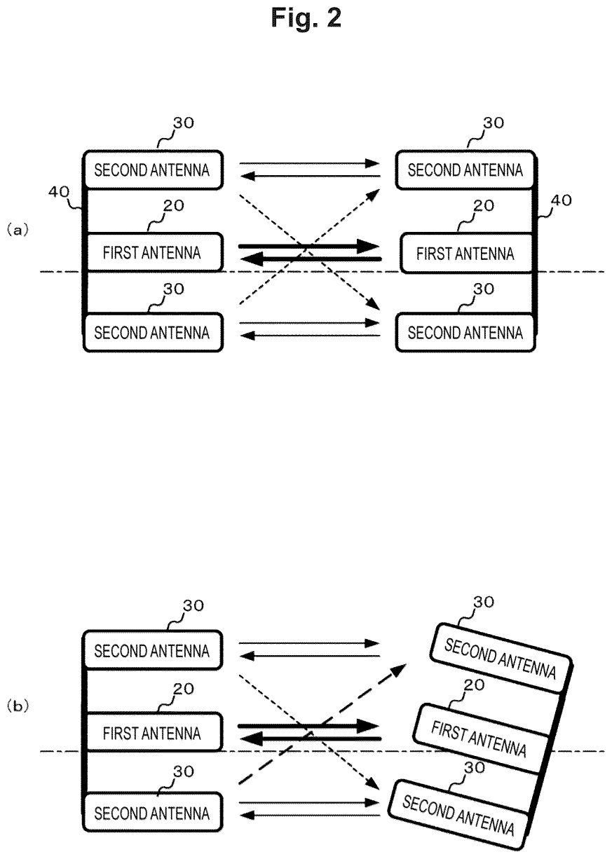

FIG. 2 is diagrams illustrating a change in direction of the first antenna 20 supported by the support member 40. FIG. 2(a) is a diagram illustrating a state in which the two first antennas 20 face each other. FIG. 2(b) is a diagram illustrating a state in which the directions of the first antennas 20 do not face each other.

The wireless communication system 10 adjusts the directions of the first antennas 20 on the basis of time differences between the radio waves received by the plurality of second antennas 30, using ease of spread and uninterrupted nature of the radio waves in the low-frequency band using the second antennas 30.

In addition, the wireless communication system 10 can grasp a facing state of each pair of the second antennas 30 even while the radio in the high-frequency band using the first antenna 20 is interrupted, and can be quickly recovered (correct the direction of the first antenna 20) even when the directions of the first antennas 20 are shifted.

In addition, the wireless communication system 10 can achieve a communication speed exceeding that of wireless communication using only the first antennas 20 by combining the wireless communication using the first antennas 20 and the wireless communication using the second antennas 30.

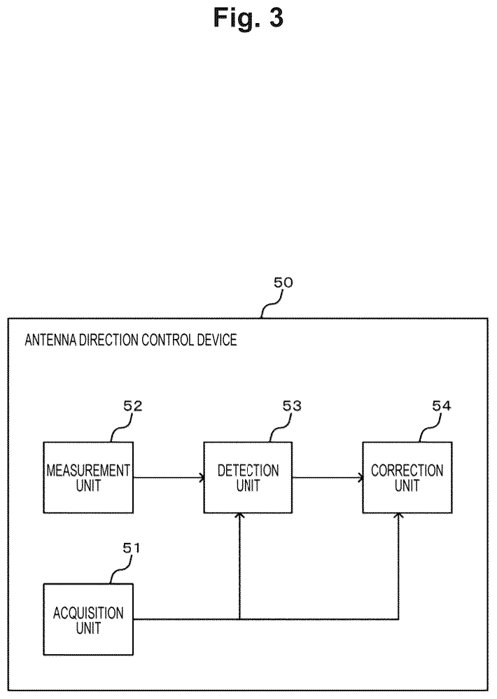

Next, functions of the antenna direction control device 50 will be described. FIG. 3 is a functional block diagram illustrating functions of the antenna direction control device 50 according to an embodiment. As illustrated in FIG. 3, the antenna direction control device 50 includes, for example, an acquisition unit 51, a measurement unit 52, a detection unit 53, and a correction unit 54, and controls each unit constituting the wireless communication system 10.

The acquisition unit 51 acquires, for example, a parameter related to the electromagnetic wave transmitted by each of the first antennas 20 and the second antennas 30, and outputs the parameter to the detection unit 53 and the correction unit 54. For example, the acquisition unit 51 acquires MIMO operation parameters such as reception power and throughput of each of the second antennas 30.

The measurement unit 52 measures differences between arrival times of the direct waves received by the plurality of second antennas 30 fixed to one support member 40 from the other identical second antennas 30, and outputs the differences to the detection unit 53.

The detection unit 53 detects a shift in a facing direction between the first antenna 20 and the other first antenna 20 on the basis of the differences between the arrival times measured by the measurement unit 52, and outputs the shift to the correction unit 54.

The correction unit 54 corrects the direction of the first antenna 20 fixed to support member 40 on the basis of the shift in the facing direction detected by the detection unit 53. Further, the correction unit 54 may correct the direction of the first antenna 20 fixed to the support member 40 so as to maximize the quality of the communication by the second antenna 30 on the basis of the parameter acquired by the acquisition unit 51. That is, the correction unit 54 performs control to change the direction of the support member 40 to correct the two first antennas 20 to face each other.

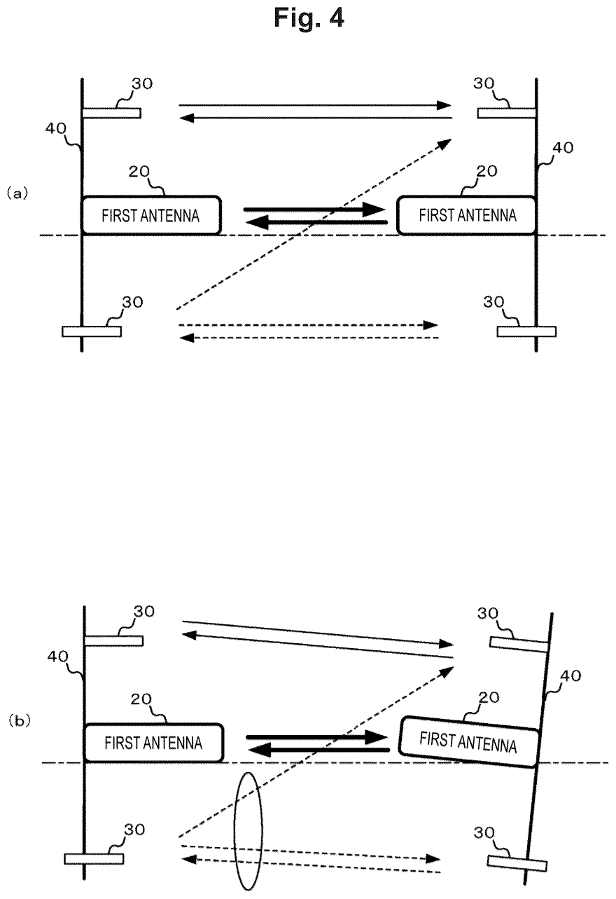

Next, the respective directions of the first antennas 20, the second antennas 30, and the support members 40 will be described in more detail. FIG. 4 is diagrams schematically illustrating specific arrangement examples of each of the first antennas 20, the second antennas 30, and the support members 40. FIG. 4(a) is a diagram schematically illustrating a state in which the two first antennas 20 face each other. FIG. 4(b) is a diagram schematically illustrating a state in which the two first antennas 20 do not face each other.

More specifically, the second antenna 30 is fixed to the support member 40 so as to be shifted in a predetermined direction with respect to the other second antenna 30 by a width (for example, a width corresponding to one wavelength) in units of wavelengths of the direct waves to be transmitted. That is, the plurality of pairs of second antennas 30 is arranged offset so that the MIMO communication has the maximum quality in the state where the optical axes are accurately aligned. This is to facilitate measurement of the difference between arrival times of the direct waves by the measurement unit 52.

Here, the predetermined direction is assumed to be a direction in which the two first antennas 20 face each other. That is, the predetermined direction is a face-to-face direction of the first antenna 20 (an optical axis direction in a case where the first antenna 20 is a device that transmits and receives light).

An offset amount of the arrangement of the second antennas 30 is adjusted to, for example, one wavelength so that the performance of the MIMO communication is maximized, and facilitates signal separation on the basis of the difference between arrival times of the radio waves received by the second antennas 30. For example, in a case where optical axis correction performance of the first antenna 20 is 1 degree, the distance of the second antenna 30 from the optical axis is about 60 times (tan 1 degree).

That is, a front-rear position (offset amount) of the second antenna 30 where the communication performance is maximized falls within at least one wavelength. Therefore, if the distance of the second antenna 30 from the optical axis is appropriate, the distance falls within the optical axis correction performance of the first antenna 20.

Since the electromagnetic wave transmitted by the first antenna 20 is an electromagnetic wave in a high-frequency band, the electromagnetic wave has high linearity and reaches only the first antenna 20 in front.

Since the radio wave transmitted by the second antenna 30 has a frequency lower than the electromagnetic wave transmitted by the first antenna 20 and has a strong tendency to diffuse, the radio wave also reaches the diagonally opposite second antenna 30 in addition to the second antenna 30 in front.

At the start of use of the wireless communication system 10, the MIMO communication can be connected by aligning the directions such that the plurality of pairs of second antennas 30 substantially faces each other.

As illustrated in FIG. 4(b), in the case where the two first antennas 20 do not directly face each other and a directional shift occurs, the radio in the high-frequency band by the first antennas 20 is disconnected. On the other hand, the communication between the plurality of pairs of second antennas 30 is hardly interrupted even if the antennas do not face each other because of the low-frequency band.

At this time, the radio waves received by the first antenna 20 are the radio wave transmitted by the first antenna 20 in front (referred to as a low-frequency band A system) and the radio wave transmitted by the diagonally opposite first antenna 20 (a low-frequency band B system), and a difference occurs between the arrival times of the radio wave of the low-frequency band A system and the radio wave of the low-frequency band B system. At this point, the difference between the arrival times of the radio waves is recognizable because the difference is different from that in the case where the plurality of pairs of second antennas 30 directly faces each other.

Therefore, the correction unit 54 performs control so as to equalize the differences in arrival time between the radio wave in the low-frequency band A system and the radio waves in the low-frequency band B systems, thereby allowing the two first antennas 20 to face each other.

Further, the plurality of pairs of second antennas 30 can transmit data indicating the shift between the two first antennas 20, the state of the wireless communication in a high-frequency band, and the like while continuing the communication.

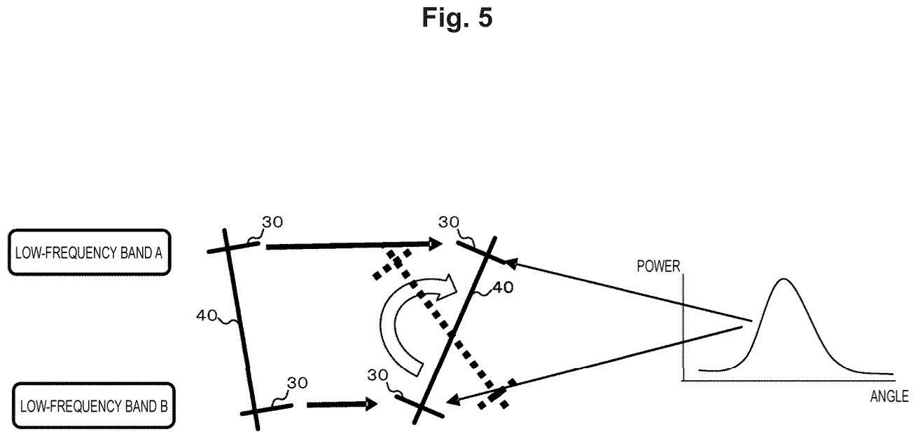

FIG. 5 is a diagram schematically illustrating a first operation example in the case where the wireless communication system 10 corrects the direction of the first antenna 20. The antenna direction control device 50 measures a distribution of reception power received by the second antenna 30 by inclining the support member 40 within the movable range in a vertical axis direction and a horizontal axis direction, and adjusts the direction of the support member 40 in the direction in which the reception power is the strongest.

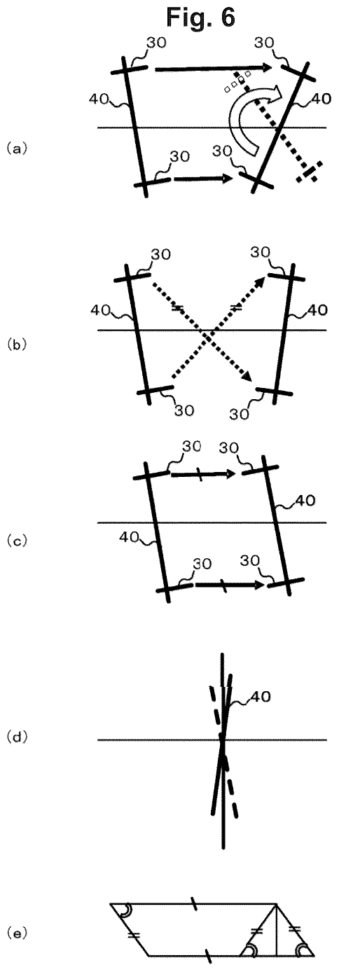

FIG. 6 is diagrams schematically illustrating a second operation example in the case where the wireless communication system 10 corrects the direction of the first antenna 20. FIG. 6(a) is a diagram illustrating a state in which the direction of the support member 40 is inclined in a predetermined direction. FIG. 6(b) is a diagram illustrating positions where the second antennas 30 do not face each other but the differences between the arrival times of the radio waves received by the two second antennas 30 are equal. FIG. 6(c) is a diagram illustrating positions where the second antennas 30 do not face each other, but the differences between the arrival times of the radio waves directly received for the respective pairs by the second antennas 30 are equal. FIG. 6(d) is a diagram illustrating a process of determining an angle for correcting the support member 40 by obtaining an intermediate angle of the inclinations of the support member 40 illustrated in FIG. 6(c) and 6(d). FIG. 6(e) is a diagram illustrating a relationship of the angles illustrated in FIG. 6(d).

In this manner, the wireless communication system 10 can guide the direction of the first antenna 20 within an optical axis correctable range by performing correction to improve the quality of the MIMO communication while continuing the communication by the plurality of pairs of second antennas 30.

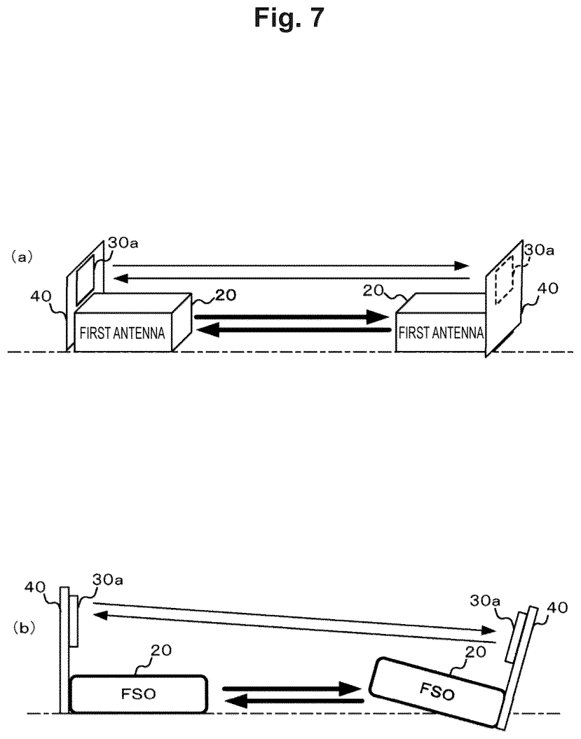

Next, a modification of the wireless communication system 10 will be described. FIG. 7 is diagrams illustrating a peripheral configuration of the first antenna 20 in the modification of the wireless communication system 10. FIG. 7(a) is a diagram illustrating a state in which the two first antennas 20 face each other in the modification of the wireless communication system 10. FIG. 7(b) is a diagram illustrating a state in which the two first antennas 20 do not face each other in the modification of the wireless communication system 10.

In the modification of the wireless communication system 10, patch array antennas 30a are used instead of the above-described second antennas 30. The patch array antenna 30a includes a plurality of antenna elements using a frequency band lower than the first antenna 20, and has a function to combine the radio waves.

The patch array antenna 30a can set parameters for forming beamforming. Further, the measurement unit 52 can measure the difference in arrival time between the individual antenna elements of the radio waves received by the patch array antenna 30a. For example, it is possible to align the optical axis of the wireless communication system 10 by controlling directivity of the patch array antenna 30a to the front (90 degrees).

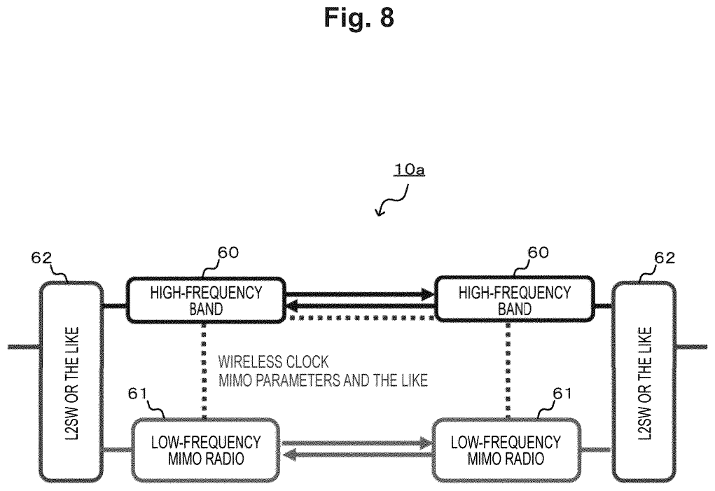

Next, an example of the wireless communication system 10 will be described. FIG. 8 is a diagram illustrating an example (wireless communication system 10a) of the wireless communication system. The wireless communication system 10a has high-frequency band devices 60 each including the wireless communication system 10 and low-frequency MIMO wireless devices 61 each including the plurality of second antennas 30 coupled by L2SW 62, and performs wireless communication using a high-frequency band and a low-frequency band.

The wireless communication system 10a can detect the shift in the facing direction between the first antenna 20 and the other first antenna 20 on the basis of the differences in arrival times measured by the measurement unit 52, and can easily correct the directions of the two antennas that transmit and receive the electromagnetic waves having a frequency higher than a predetermined frequency to and from each other while facing each other.

In addition, the wireless communication system 10 can enhance the continuity of the wireless communication using a technique (for example, LAG) of bundling bands, and can also enhance recoverability. In addition, the wireless communication system 10 can improve throughput by performing auxiliary transmission of a low-frequency wireless clock and the MIMO parameters on the high-frequency side during normal communication.

Note that some or all of the functions of the antenna direction control device 50 may be configured with hardware such as a programmable logic device (PLD) or a field programmable gate array (FPGA) or may be configured as a program executed by a processor such as a CPU.

For example, the antenna direction control device 50 can be implemented using a computer and a program, and the program can be recorded in a storage medium or provided through a network.

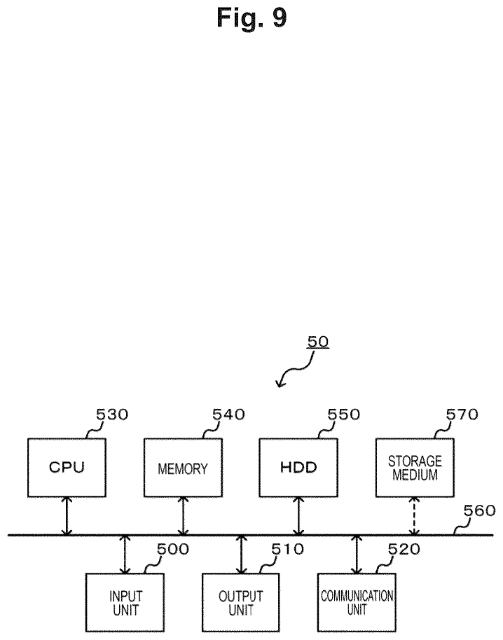

FIG. 9 is a diagram illustrating a hardware configuration example of the antenna direction control device 50 according to the embodiment. As illustrated in FIG. 9, the antenna direction control device 50 has a function as a computer in which an input unit 500, an output unit 510, a communication unit 520, a CPU 530, a memory 540, and an HDD 550 are connected via a bus 560 Further, the antenna direction control device 50 can input and output data to and from a computer-readable storage medium 570.

The input unit 500 is, for example, a keyboard, a mouse, or the like. The output unit 510 is, for example, a display device such as a display.

The communication unit 520 is a communication interface that performs wireless communication.

The CPU 530 controls each unit constituting the antenna direction control device 50 and performs predetermined processing and the like. The memory 540 and the HDD 550 store data and the like.

The storage medium 570 can store a program and the like for executing the functions of the antenna direction control device 50. Note that an architecture that configures the antenna direction control device 50 is not limited to the example illustrated in FIG. 9.

### REFERENCE SIGNS LIST

10, 10a Wireless communication system
20 First antenna
30 Second antenna
40 Support member
50 Antenna direction control device
51 Acquisition unit
52 Measurement unit
53 Detection unit
54 Correction unit
30a Patch array antenna
60 High-frequency band device
61 Low-frequency MIMO wireless device
62 L2SW
500 Input unit
510 Output unit
520 Communication unit
530 CPU
540 Memory
550 HDD
560 Bus
570 Storage medium

1. A wireless communication system comprising:
two first antennas configured to transmit and receive an electromagnetic wave having a frequency higher than a predetermined frequency to and from each other while facing each other;
a plurality of pairs of second antennas configured to transmit and receive a direct wave having a frequency lower than the predetermined frequency to and from each other while facing each other;
two support members each fixing one of the first antennas and a plurality of the second antennas so as to be integrated toward a same direction, and the two support members configured to support the two first antennas and the plurality of the second antennas forming the pairs to respectively face each other within a predetermined movable range;
measurement circuitry configured to measure a difference between arrival times of the direct waves received by the plurality of second antennas fixed to one of the support members from the other identical second antennas; and
detection circuitry configured to detect a shift in a facing direction between the first antenna and the other first antenna on a basis of the difference between arrival times measured by the measurement circuitry.

2. The wireless communication system according to claim 1, wherein
the second antenna
is fixed to the support member so as to be shifted in the same direction with respect to the other second antenna with a width of a wavelength unit of the direct wave to be transmitted.

3. The wireless communication system according to claim 1, further comprising:
correction circuitry configured to correct a direction of the first antenna fixed to the support member on a basis of the shift in the facing direction detected by the detection circuitry.

4. An antenna direction control device that controls an antenna direction of a wireless communication system including two first antennas configured to transmit and receive an electromagnetic wave having a frequency higher than a predetermined frequency to and from each other while facing each other, a plurality of pairs of second antennas configured to transmit and receive a direct wave having a frequency lower than the predetermined frequency to and from each other while facing each other, and two support members each fixing one of the first antennas and a plurality of the second antennas so as to be integrated toward a same direction, and the two support members configured to support the two first antennas and the plurality of the second antennas forming the pairs to respectively face each other within a predetermined movable range, the antenna direction control device comprising:
measurement circuitry configured to measure a difference between arrival times of the direct waves received by the plurality of second antennas fixed to one of the support members from the other identical second antennas;
detection circuitry configured to detect a shift in a facing direction between the first antenna and the other first antenna on a basis of the difference between arrival times measured by the measurement circuitry; and
correction circuitry configured to correct a direction of the first antenna fixed to the support member on a basis of the shift in the facing direction detected by the detection circuitry.

5. An antenna direction control method for controlling an antenna direction of a wireless communication system including two first antennas configured to transmit and receive an electromagnetic wave having a frequency higher than a predetermined frequency to and from each other while facing each other, a plurality of pairs of second antennas configured to transmit and receive a direct wave having a frequency lower than the predetermined frequency to and from each other while facing each other, and two support members each fixing one of the first antennas and a plurality of the second antennas so as to be integrated toward a same direction, and the two support members configured to support the two first antennas and the plurality of the second antennas forming the pairs to respectively face each other within a predetermined movable range, the antenna direction control method comprising:
measuring a difference between arrival times of the direct waves received by the plurality of second antennas fixed to one of the support members from the other identical second antennas; and
detecting a shift in a facing direction between the first antenna and the other first antenna on a basis of the measured difference between arrival times.

6. The antenna direction control method according to claim 5, wherein
the second antenna
is fixed to the support member so as to be shifted in the same direction with respect to the other second antenna with a width of a wavelength unit of the direct wave to be transmitted.

7. The antenna direction control method according to claim 5, further comprising:
correcting a direction of the first antenna fixed to the support member on a basis of the shift in the facing direction detected by detecting process.

8. A non-transitory computer-readable storage medium storing an antenna direction control program for causing a computer to function as each circuitry of the antenna direction control device according to claim 4.
